(19) United States
(12) Patent Application Publication
(10) Pub. No.: US 2024/0404148 A1
(43) Pub. Date: Dec. 5, 2024

(54) METHOD FOR EDITING MOVING IMAGE, STORAGE MEDIUM STORING EDITING PROGRAM, AND EDITING DEVICE

(71) Applicant: LY CORPORATION, Tokyo (JP)

(72) Inventors: Ryuichi YAMAMOTO, Tokyo (JP); Yusuke FUJITA, Tokyo (JP); Tatsuya KOMATSU, Tokyo (JP); Byeongseon PARK, Tokyo (JP); Robin SCHEIBLER, Tokyo (JP)

(73) Assignee: LY CORPORATION, Tokyo (JP)

(21) Appl. No.: 18/680,101

(22) Filed: May 31, 2024

(30) Foreign Application Priority Data
Jun. 2, 2023 (JP) 2023-091798

(51) Int. Cl. G06T 11/60; G06V 10/44

(52) U.S. Cl. CPC G06T 11/60; G06V 10/44; G06V 2201/07

(57) ABSTRACT

A method for editing a moving image by a computer includes obtaining the moving image, extracting a specific timing in the moving image by analyzing the moving image, and adding at least one sound effect to the specific timing. Furthermore, a method for editing a moving image by a computer includes obtaining the moving image, dividing the moving image into one or more scenes by analyzing the moving image, determining a characteristic of each of the one or more scenes, and determining a background sound to be added to each scene based on the characteristic

### CROSS-REFERENCE TO RELATED APPLICATIONS

The present application claims priority under 35 U.S.C. § 119 to Japanese Patent Application No. 2023-091798, filed Jun. 2, 2023, the contents of which are incorporated herein by reference in their entirety.

### BACKGROUND

### Field

The present disclosure relates to methods for editing a moving image, non-transitory computer-readable storage mediums storing an editing program, and editing devices.

### Description of the Related Art

A generation device for generating music data from an image includes face detection means for analyzing whether a face is included in the image, face attribute analysis means for analyzing an attribute of the face in a case where the face is determined to be included in the image by the face detection means, and music data generation means for generating music data based on the attribute of the face analyzed by the face attribute analysis means.

The generation device generates music in relation to a single still image. By contrast, unlike a single still image, a moving image includes temporal changes, such as introduction, development, twist, and conclusion, and thus, there may be more than one pieces of music or audible effect that match one moving image and that represents each time in the moving image. However, an audible effect, such as music, that matches a change cannot be added to a moving image including a temporal change.

### SUMMARY

Some example embodiments of the present disclosure provide methods for editing a moving image, non-transitory computer-readable storage mediums storing an editing program, and editing devices that are capable of adding an audible effect according to a change in a moving image.

According to an example embodiments of the present disclosure, a method for editing a moving image by a computer may include obtaining the moving image, extracting a specific timing in the moving image by analyzing the moving image, and adding at least one sound effect to the specific timing.

According to an example embodiments of the present disclosure, a method for editing a moving image by a computer may include obtaining the moving image, dividing the moving image into one or more scenes by analyzing the moving image, determining a characteristic of each of the one or more scenes, and determining a background sound to be added to each of the one or more scenes, based on the characteristic determined for a corresponding one of the one or more scenes.

According to an example embodiment of the present disclosure, there is provided a non-transitory computer-readable storage medium storing an editing program, which when executed by at least one processor, causes a computer to perform the above methods for editing.

According to an example embodiments of the present disclosure, there is provided an editing device configured to perform the above methods for editing a the moving image.

With the above methods for editing, the above editing program, or the above editing device according to some example embodiments of the present disclosure, it is possible to add, to a moving image including a change, an audible effect according to the change.

### BRIEF DESCRIPTION OF DRAWINGS

FIG. 1 is a configuration diagram of an editing system according to an example embodiment.

FIG. 2 is a diagram illustrating an example configuration of each device included in the editing system of FIG. 1.

FIG. 3 is a an example sound effect table of the editing system of FIG. 1.

FIG. 4 is a flowchart illustrating an example operation of the editing system of FIG. 1.

FIG. 5 is a diagram illustrating a configuration of each device included in an editing system according to an example embodiment.

FIG. 6 is a an example background sound table of the editing system of FIG. 5.

FIG. 7 is a flowchart illustrating an example operation of the editing system of FIG. 5.

### DETAILED DESCRIPTION

Some example embodiments for embodying the present disclosure will be described with reference to the appended drawings. In the drawings, same or corresponding parts are denoted by a same reference sign, and overlapping description is simplified or omitted as appropriate. Additionally, example embodiments of the present disclosure are not limited to the following example embodiments, and structural elements may be added, modified, or omitted within the scope of the claims.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the term “about,” “substantially” or “approximately” is used in this specification in connection with a numerical value, it is intended that the associated numerical value includes a manufacturing or operational tolerance (e.g., ±10%) around the stated numerical value. Moreover, when the word “about,” “substantially” or “approximately” is used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

### First Example Embodiment

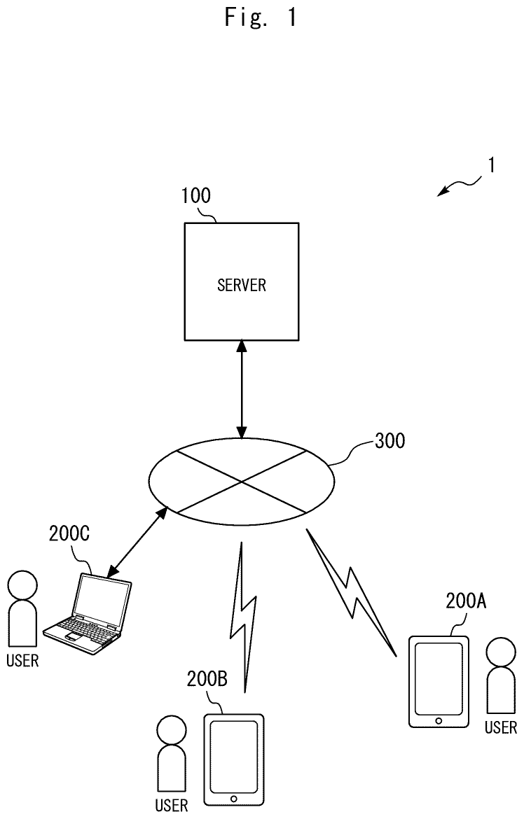

FIG. 1 is a configuration diagram of an editing system 1 according to an example embodiment.

The editing system 1 is a system for editing a moving image. In the present example, the editing system 1 edits a moving image that is recorded as a single file. For example, data of the moving image includes a plurality of frames corresponding to respective time points or information such as a difference between frames, and is data that expresses an image that changes over time. In the present example, data of the moving image includes information about an image that changes over time, and information about sound that changes over time. However, a moving image as a target of the present inventive concepts is not limited to a specific moving image, and any moving image may be taken as the target.

In the present example, the editing system 1 operates on a communication system where a server 100 and an information terminal 200A are connected via a network 300. In the communication system, an information terminal 200B, an information terminal 200C and the like are connected to the server 100 via the network 300. Here, in the case where the information terminal 200A, the information terminal 200B, and the information terminal 200C do not have to be distinguished from one another, a term “information terminal(s) 200” may be used. Additionally, the number of information terminals 200 to be connected to the network 300 is not particularly specified. Editing of a moving image by the editing system 1 is performed through the information terminal 200 that is used by a user of the editing system 1, for example. The server 100 communicates data including a moving image as a target of editing and a moving image after editing with the information terminal 200 that is used by the user of the editing system 1, via the network 300.

The network 300 serves to connect at least one information terminal 200 and the server 100. That is, the network 300 is a communication network that provides a connection path such that data can be transmitted/received after the information terminal 200 is connected to the server 100.

One or more parts of the network 300 may, but do not have to be, a wired network or a wireless network. For example, but not by way of limitation, the network 300 may be an Ad hoc Network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), a part of the Internet, a part of a Public Switched Telephone Network (PSTN), a mobile telephone network, Integrated Service Digital Networks (ISDN), Long Term Evolution (LTE), Code Division Multiple Access (CDMA), Bluetooth (registered trademark), satellite communications, or a combination of two or more of those listed above. The network 300 may include one or more networks.

The information terminal 200 may be any terminal device that performs information processing as long as the information terminal 200 is a terminal device that is able to achieve functions described in at least one example embodiment. For example, but not by way of limitation, the information terminal 200 may be a smartphone, a mobile phone (a feature phone), a computer (for example, but not by way of limitation, a personal computer (PC) such as a desktop, a laptop, or a tablet), a media computer platform (for example, but not by way of limitation, a cable/satellite set-top box, or a digital video recorder), a handheld computer device (for example, but not by way of limitation, a personal digital assistant (PDA) or an electronic mail client), a wearable terminal (such as a glass-type device or a watch-type device), any other type of computer, or a communication platform.

The server 100 includes a function of providing a desired (or alternatively, predetermined) service to the information terminal 200. The server 100 may be any device as long as the server 100 is an information processing apparatus that can achieve functions described in each example embodiment. For example, but not by way of limitation, the server 100 may be a server device, a computer (for example, but not by way of limitation, a desktop, a laptop, or a tablet), a media computer platform (for example, but not by way of limitation, a cable/satellite set-top box, or a digital video recorder), a handheld computer device (for example, but not by way of limitation, a PDA, or an electronic mail client), any other type of computer, or a communication platform. The server 100 may be an information processing apparatus such as a single server device, or may be a computer system including a plurality of information processing apparatuses that are connected in a manner capable of communicating with one another. At least one or all of the functions of the server 100 may be implemented on a virtual machine on a cloud service, or may be implemented by storage resources or processes provided by a cloud service.

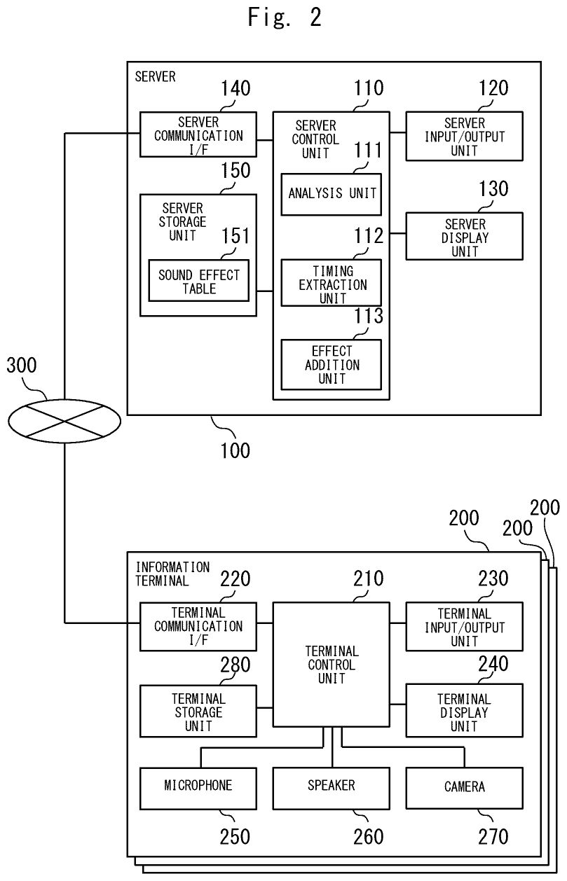

FIG. 2 is a diagram illustrating an example configuration of each device included in the editing system 1 of FIG. 1.

An example hardware configuration of each device included in the editing system 1 of FIG. 1 will be described with reference to FIG. 2.

The information terminal 200 includes a terminal control unit 210, a terminal storage unit 280, a terminal communication I/F 220 (I/F: interface), a terminal input/output unit 230, a terminal display unit 240, a microphone 250, a speaker 260, and a camera 270. For example, but not by way of limitation, structural elements of hardware of the information terminal 200 are interconnected by a bus. Additionally, the information terminal 200 does not have to include all of the structural elements mentioned above as hardware configuration. For example, but not by way of limitation, the information terminal 200 may, but does not have to, have a configuration where an individual structural element such as the microphone 250 or the camera 270, or a plurality of structural elements is/are not included.

The terminal communication I/F 220 transmits/receives various pieces of data via the network 300. Such communication may be performed in a wired or wireless manner, and any communication protocol may be used as long as communication can be performed. The terminal communication I/F 220 includes a function of performing communication with the server 100 via the network 300. The terminal communication I/F 220 transmits various pieces of data to the server 100 according to an instruction from the terminal control unit 210. Furthermore, the terminal communication I/F 220 receives various pieces of data transmitted from the server 100, and transfers the same to the terminal control unit 210. The terminal communication I/F 220 may simply be referred to as a communication unit. Moreover, in the case where the terminal communication I/F 220 is configured by a physically structured circuit, a term “communication circuit” may be used.

The terminal input/output unit 230 includes a device that inputs various operations to the information terminal 200, and a device that outputs a result of processing performed by the information terminal 200. The terminal input/output unit 230 may include an input unit and an output unit that are integrated, or may include separate input unit and output unit, for example. The input unit is implemented by any type of device that is capable of receiving an input from a user and of transferring information about the input to the terminal control unit 210, or a combination of such devices. For example, but not by way of limitation, the input unit may be a touch panel, a touch display, a hardware key such as a keyboard, a pointing device such as a mouse, a camera (operation input via a moving image), or a microphone (operation input via audio). The output unit is implemented by any type of device that is capable of outputting a result of processing performed by the terminal control unit 210, or a combination of such devices. For example, but not by way of limitation, the output unit may be a touch panel, a touch display, a speaker (audio output), a lens (for example, but not by way of limitation, 3D (three dimensions) output or hologram output), or a printer.

The terminal display unit 240 is implemented by any type of device that is capable of performing display according to display data written in a frame buffer, or a combination of such devices. For example, but not by way of limitation, the terminal display unit 240 may be a touch panel, a touch display, a monitor (for example, but not by way of limitation, a liquid crystal display or an organic electroluminescence display (OELD)), a head mounted display (HMD), projection mapping, a hologram, or a device that is capable of displaying an image, text information or the like in the air (may, but does not have to, be vacuum). Additionally, such terminal display unit 240 may, but does not have to, be capable of displaying display data in 3D.

In the case where the terminal input/output unit 230 is a touch panel, the terminal input/output unit 230 and the terminal display unit 240 may, but do not have to, be disposed facing each other while having substantially same sizes and shapes.

The terminal control unit 210 includes a physically structured circuit for implementing a function that is implemented by a code or a command in a program, and is implemented by, for example, but not by way of limitation, a data processing device that is built in hardware. Accordingly, the terminal control unit 210 may, but does not have to, to referred to as a control circuit. For example, but not by way of limitation, the terminal control unit 210 may be a central processing unit (CPU), a microprocessor, a processor core, a multiprocessor, an Application-Specific Integrated Circuit (ASIC), or a Field Programmable Gate Array (FPGA).

The terminal storage unit 280 includes a function of storing various programs, various pieces of data, and the like that are necessary or desired for the information terminal 200 to operate. For example, but not by way of limitation, the terminal storage unit 280 may include various storage media such as a Hard Disk Drive (HDD), a Solid State Drive (SSD), a flash memory, a Random Access Memory (RAM), and a Read Only Memory (ROM). Furthermore, the terminal storage unit 280 may, but does not have to, be referred to as a memory.

The information terminal 200 stores a program in the terminal storage unit 280 and executes the program so that the terminal control unit 210 performs processes as each component included in the terminal control unit 210. That is, the program stored in the terminal storage unit 280 causes the information terminal 200 to implement each function that is executed by the terminal control unit 210. The program may, but does not have to, be referred to as a program module.

The microphone 250 is used for input of audio data. The speaker 260 is used for output of audio data. The camera 270 is used to obtain a still image, moving image data, and the like. Here, data of a moving image may include information about an image obtained by the camera 270, and information about audio obtained by the microphone 250.

The server 100 includes a server control unit 110, a server storage unit 150, a server communication I/F 140, a server input/output unit 120, and a server display unit 130. For example, but not by way of limitation, structural elements of hardware of the server 100 are interconnected by a bus. Additionally, the server 100 does not have to include all of the structural elements mentioned above as hardware configuration. For example, but not by way of limitation, the server 100 may, but does not have to, have a configuration where the server display unit 130 is not included. In the case where the server 100 is a computer system including a plurality of information processing apparatuses, the structural elements of the server 100 mentioned above may, but do not have to, be mounted on different information processing apparatuses. Furthermore, each structural element of the server 100 mentioned above may be mounted on a plurality of information processing apparatuses.

The server control unit 110 includes a physically structured circuit for implementing a function that is implemented by a code or a command in a program, and is implemented by, for example, but not by way of limitation, a data processing device that is built in hardware. The server control unit 110 is typically a central processing unit (CPU), but instead, the server control unit 110 may, but is not limited to, be a microprocessor, a processor core, a multiprocessor, an ASIC, or an FPGA. In example embodiments of the present disclosure, the server control unit 110 is not limited to those listed above.

The server storage unit 150 includes a function of storing various programs, various pieces of data, and the like that are necessary or desired for the server 100 to operate. The server storage unit 150 is implemented by various storage media such as an HDD, an SSD, and a flash memory. However, in example embodiments of the present disclosure, the server storage unit 150 is not limited to those mentioned above. Furthermore, the server storage unit 150 may, but does not have to, be referred to as a memory.

The server communication I/F 140 transmits/receives various pieces of data via the network 300. Such communication may be performed in a wired or wireless manner, and any communication protocol may be used as long as communication can be performed. The server communication I/F 140 includes a function of performing communication with the information terminal 200 via the network 300. The server communication I/F 140 transmits various pieces of data to the information terminal 200 according to an instruction from the server control unit 110. Furthermore, the server communication I/F 140 receives various pieces of data transmitted from the information terminal 200, and transfers the same to the server control unit 110. The server communication I/F 140 may simply be referred to as a communication unit. Moreover, in the case where the server communication I/F 140 is configured by a physically structured circuit, a term “communication circuit” may be used.

The server input/output unit 120 is implemented by a device that inputs various operations to the server 100. The server input/output unit 120 is implemented by any type of device that is capable of receiving an input from an operator of the server 100 and of transferring information about the input to the server control unit 110, or a combination of such devices. The server input/output unit 120 is typically implemented by a hardware key represented by a keyboard, or a pointing device such as a mouse. For example, but not by way of limitation, the server input/output unit 120 may, but does not have to, include a touch panel or a camera (operation input via moving image), or a microphone (operation input via audio). However, in example embodiments of the present disclosure, the server input/output unit 120 is not limited to those listed above.

The server display unit 130 is typically implemented by a monitor (for example, but not by way of limitation, a liquid crystal display or an OELD). Additionally, the server display unit 130 may, but does not have to, be an HMD. Additionally, such a server display unit 130 may, but does not have to, be capable of displaying display data in 3D. In example embodiments of the present disclosure, the server display unit 130 is not limited to those listed above.

The server 100 stores a program in the server storage unit 150 and executes the program so that the server control unit 110 performs processes as each component included in the server control unit 110. That is, the program stored in the server storage unit 150 causes the server 100 to implement each function that is executed by the server control unit 110. The program may, but does not have to, be referred to as a program module.

Additionally, for example, the terminal control unit 210 of the information terminal 200 and/or the server control unit 110 of the server 100 may implement each process not only by a CPU including a control circuit, but also by a logical circuit (hardware) or a dedicated circuit formed on an integrated circuit (IC) chip, a large scale integration (LSI) or the like. Furthermore, such circuits may be implemented by one or more integrated circuits, and a plurality of processes described in each example embodiment may, but do not have to, be implemented by one integrated circuit. Furthermore, the LSI may be referred to as a VLSI, a super LSI, an ultra LSI or the like depending on the scale of integration. Accordingly, the terminal control unit 210 and/or the server control unit 110 may, but does not have to, be referred to as a control circuit.

Moreover, a program (for example, but not by way of limitation, a software program, a computer program, a program product, or a program module) of at least one example embodiment of the present disclosure may, but does not have to, be provided in a state of being stored in a computer-readable storage medium. The program can be stored in a storage medium that is a “non-transitory tangible medium”. Furthermore, the program may, but does not have to, be for achieving some of the functions of at least one example embodiment of the present disclosure. Moreover, the program may, but does not have to, be a so-called difference file (a difference program) that can achieve the function of an example embodiment of the present disclosure in combination with a program that is already stored in the storage medium.

The storage medium may be one or more semiconductor-based or other ICs (for example, but not by way of limitation, an FPGA or an ASIC), an HDD, a hybrid hard drive (HHD), an optical disc, an optical disk drive (ODD), a magneto-optical disc, a magneto-optical drive, a floppy diskette, a Floppy disk drive (FDD), a magnetic tape, an SSD, a RAM drive, a secure digital card or a drive, any other appropriate storage medium, or an appropriate combination of two or more of those listed above. When appropriate, the storage medium may be volatile, non-volatile, or a combination of volatile and non-volatile forms. Additionally, the storage medium is not limited to the above-mentioned examples, and any device or medium may be applied as long as a program can be stored. Furthermore, the storage medium may, but does not have to, be referred to as a memory.

A description will be given assuming that each function in at least one example embodiment of the present disclosure is achieved by execution of a program by the terminal control unit 210 of the information terminal 200 and/or the server control unit 110 of the server 100. That is, the server 100 and/or the information terminal 200 may achieve functions of a plurality of functional units described in at least one example embodiment by reading out a program stored in the storage medium and executing the program that is read out.

Furthermore, a program of the present disclosure may, but does not have to, be provided to the server 100 and/or the information terminal 200 via a freely selected transmission medium (such as a communication network or a broadcast wave) that is capable of transmitting the program. For example, but not by way of limitation, the server 100 and/or the information terminal 200 achieves functions of a plurality of functional units of each embodiment by execution of a program that is downloaded via the Internet or the like.

Moreover, in at least one example embodiment of the present disclosure, a program may be implemented in the form of a data signal, embedded in a carrier wave, implemented by electronic transmission.

At least one or all of processes by the information terminal 200 may, but do not have to, be performed by the server 100. In this case, at least one or all of processes by the functional units of the terminal control unit 210 of the information terminal 200 may, but do not have to, be performed by the server 100. Furthermore, at least one or all of processes by the server 100 may, but do not have to, be performed by the information terminal 200. In this case, at least one or all of processes by the functional units of the server control unit 110 of the server 100 may, but do not have to, be performed by the information terminal 200.

Furthermore, a program to be processed by the terminal control unit 210 may be pre-installed in the information terminal 200, or may be installed, by a user, from a recording medium that is capable of connecting to the information terminal 200 from outside and of exchanging information, such as a compact disc (CD), a secure digital (SD) card or a universal serial bus (USB), or from an external server (such as a cloud server) via the Internet or the like. For example, in the case where the information terminal 200 is a smartphone, the program may be a program that is included in an application (APP) installed, by a user, in the smartphone via the Internet.

Unless explicitly stated, the configuration of determination in an example embodiment of the present disclosure is not essential. A predetermined process may be performed when a determination condition is satisfied, or a predetermined process may be performed when a determination condition is not satisfied, for example.

Additionally, a program of the present disclosure is implemented using, for example, but not by way of limitation, a script language such as ActionScript or JavaScript (registered trademark), an object-oriented programming language such as Objective-C or Java (registered trademark), or a markup language such as HTML5.

Next, examples of functions of each device included in the editing system 1 will be described with reference to FIG. 2.

A user of the editing system 1 performs an operation of transmitting a moving image as a target of editing from the information terminal 200 to the server 100. A moving image as a target of editing may be a moving image captured by the camera 270 of the information terminal 200, or a moving image captured by another image capturing device and read by the information terminal 200, or a moving image generated by the information terminal 200 or another information processing apparatus, for example. The terminal communication I/F 220 transmits data of the moving image to the server 100 via the network 300.

In the server 100, the server communication I/F 140 receives the moving image from the information terminal 200. The server control unit 110 performs an editing process on the moving image obtained from the information terminal 200, based on an editing program for a moving image stored in the server storage unit 150 or the like. The server 100 is an example of an editing device. The editing process on the moving image by the server 100 is addition of an audible effect to the moving image, for example. In the present example, the server 100 adds a sound effect as the audible effect, to a specific timing in the moving image. A specific timing in a moving image is a time point in the moving image that may be taken as a target to which a sound effect is to be added. The server communication I/F 140 returns, to the information terminal 200 via the network 300, the moving image on which the editing process is performed by the server control unit 110.

The server storage unit 150 stores a sound effect table 151. The sound effect table 151 is a data table including information associating in advance a type of a specific timing in a moving image and a sound effect.

The server control unit 110 includes an analysis unit 111, a timing extraction unit 112, and an effect addition unit 113.

The analysis unit 111 is a part that includes a function of analyzing a moving image. For example, the analysis unit 111 calculates a feature at each time point in a moving image based on analysis of one or both of an image and a sound included in the moving image, the image being visual information, the sound being auditory information. For example, the analysis unit 111 calculates a feature on a per-frame basis, where each frame included in the moving image corresponds to a respective time point in the moving image. The analysis unit 111 may calculate a plurality of features for each time point in the moving image.

For example, the analysis unit 111 detects, by image analysis, overall movement of a person in the moving image, or movement of each part of the person, such as a face, an eye, an eyebrow, a nose, a mouth, a hand, or a leg. For example, the analysis unit 111 may take an amount of such detected movement as the feature. The analysis unit 111 may estimate a feeling of a person in the moving image based on movement of a part of a face image of the person. The analysis unit 111 may take intensity of the feeling estimated based on an image and an amount of change in the intensity as the feature. Types of feeling to be estimated include joy, surprise, anger, and the like.

For example, the analysis unit 111 extracts, by sound analysis, on a per-person basis, a sound uttered by a person in the moving image by using sound source separation. The analysis unit 111 calculates a feature expressing the feeling of a person from the extracted sound of the corresponding person. Features of a sound include power, pitch, Mel-Frequency Cepstral Coefficient (MFCC), and other dynamic features, for example. The analysis unit 111 may estimate the feeling of a person based on the feature of the sound of the corresponding person in the moving image, for example. The analysis unit 111 may take intensity of the feeling estimated based on sound and an amount of change in the intensity as the feature.

For example, the analysis unit 111 may calculate a feature such as intensity of the feeling of a person in the moving image by using both image analysis and sound analysis. For example, when a smiling face of a person in the moving image detected by image analysis matches a laughing voice of the person detected by sound analysis, the analysis unit 111 estimates that the person is laughing, and calculates a corresponding feature.

The analysis unit 111 may detect a person or an object set in advance from a moving image based on analysis of one or both of an image and a sound included in an image. For example, the analysis unit 111 performs detection of a person or an object by using a feature calculated by analysis of the moving image. The object to be detected by the analysis unit 111 may be a non-living thing or a living thing. For example, the analysis unit 111 detects a dog in the moving image when an image of a part or all of the body of a dog is detected by image analysis or when a sound of barking of a dog is detected by sound analysis.

The timing extraction unit 112 is a part that includes a function of extracting a specific timing in the moving image, to which a sound effect is to be added. For example, the timing extraction unit 112 extracts one of frames included in a moving image as a specific timing in the moving image. The timing extraction unit 112 may extract a plurality of specific timings from one moving image that is recorded as one file.

For example, the timing extraction unit 112 extracts the specific timing based on a feature calculated by the analysis unit 111. For example, a feature that is used for extraction of the timing is a feature expressing the intensity of the feeling of a person in the moving image. For example, the timing extraction unit 112 may extract a time point when the feature exceeds or falls below a threshold that is set in advance as the specific timing, or may extract a time point when an amount of change in the feature exceeds or falls below a threshold that is set in advance as the specific timing, or may extract a time point when the feature reaches a local maximum value or a local minimum value as the specific timing, or may extract a time point in the moving image as the specific timing according to any other criterion based on the feature. The timing extraction unit 112 extracts, as the specific timing, a time point that visually or auditorily matches a timing when the feeling of the person appearing in the moving image is intensified.

For example, the timing extraction unit 112 extracts the specific timing based on the feeling of a person in the moving image estimated by the analysis unit 111. For example, when a section where a person in the moving image is expressing a feeling that is set in advance is detected by the analysis unit 111, the timing extraction unit 112 extracts a time point of start or end of the section as the specific timing. A section where a person in the moving image is expressing a feeling that is set in advance is a section where the person is laughing, for example.

The timing extraction unit 112 extracts the specific timing based on a result of detection of a person or an object by the analysis unit 111, for example. When a section where a person or an object that is set in advance appears is detected in the moving image by the analysis unit 111, the timing extraction unit 112 extracts a time point of start or end of the section as the specific timing, for example.

The effect addition unit 113 is a part that includes a function of adding an effect to a specific timing extracted from the moving image by the timing extraction unit 112. For example, the effect addition unit 113 adds an audible effect such as a sound effect to the specific timing that is extracted.

For example, the effect addition unit 113 adds an effect to the specific timing by referring to the sound effect table 151 stored in the server storage unit 150. The sound effect table 151 associates the type of a feeling of a person in the moving image that is expressed by a feature that is obtained by analyzing the moving image, with a sound effect corresponding to the feeling, for example. The sound effect table 151 may associate different sound effects with feelings of a same type, depending on the intensities of the feelings. Furthermore, the sound effect table 151 associates, with a person or an object detected by the analysis unit 111, a sound effect corresponding to the person or the object. For example, by referring to the sound effect table 151, the effect addition unit 113 adds, to a specific timing indicating start of a section where a person is laughing, a laughing voice that is the sound effect corresponding to the specific timing. For example, by referring to the sound effect table 151, the effect addition unit 113 adds, to a specific timing that is extracted based on a feature expressing surprise, a sound effect expressing surprise corresponding to the specific timing. For example, by referring to the sound effect table 151, the effect addition unit 113 adds, to a specific timing indicating start of a section where a dog appears, a sound effect that is a barking sound of a dog. For example, by referring to the sound effect table 151, the effect addition unit 113 adds, to a specific timing indicating start of a section of rain, a sound effect that is a sound of falling rain.

For example, the effect addition unit 113 adds a sound effect that is dynamically generated, based on an analysis result of the moving image at the specific timing. The effect addition unit 113 adds a sound effect that is dynamically generated by using a learning model learned in advance by a method such as machine learning and by taking an analysis result by the analysis unit 111 as an input, for example. The effect addition unit 113 may dynamically generate a sound effect by AI technology (AI: Artificial Intelligence) or the like, or may dynamically generate the sound effect by a different method. The sound effect that is generated at this time may be a sound effect that is newly generated, or may be a sound effect where a parameter of an existing sound effect, such as intensity, length or the like, is dynamically set. An analysis result of a moving image that is used as an input for generation of the sound effect may be a feature calculated from the moving image, the type and intensity of the feeling of a person estimated from the moving image, or the type of an object or a person detected in the moving image. For example, the effect addition unit 113 adds, to a specific timing indicating start of a section where a person is laughing, a sound effect that is a laughing voice dynamically generated to match the intensity of the laughing feeling in the section. For example, the effect addition unit 113 adds, to a specific timing that is extracted based on a feature expressing a feeling of anger, a sound effect expressing anger that is dynamically generated to match the intensity of the feature.

Additionally, the effect addition unit 113 may overlappingly add a plurality of sound effects to one specific timing. Furthermore, for example, in the case where a plurality of specific timings are extracted by the timing extraction unit 112, the effect addition unit 113 does not have to add an effect to every specific timing.

Furthermore, the effect addition unit 113 may add a visual effect in addition to an audible effect, to a specific timing extracted from the moving image by the timing extraction unit 112.

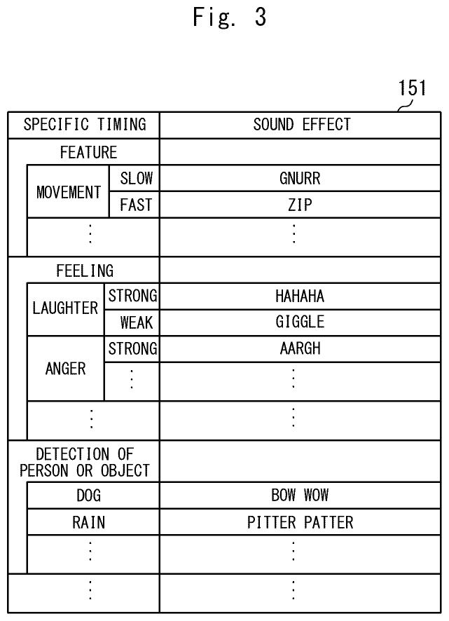

FIG. 3 is an example sound effect table 151 of the editing system 1 of FIG. 1.

For example, in the sound effect table 151, a feature such as speed of a movement is associated with a sound effect that is different depending on the size of the feature. For example, association of the sound effect is performed according to a range of numerical values indicating the size of the feature. For example, the sound effect table 151 associates, with the feeling of anger, a sound effect that is different depending on the intensity of the feeling. For example, association of the sound effect is performed according to a range of numerical values indicating the intensity of the feeling. For example, the sound effect table 151 associates a sound effect that is a barking sound of a dog in relation to detection of a dog in the moving image.

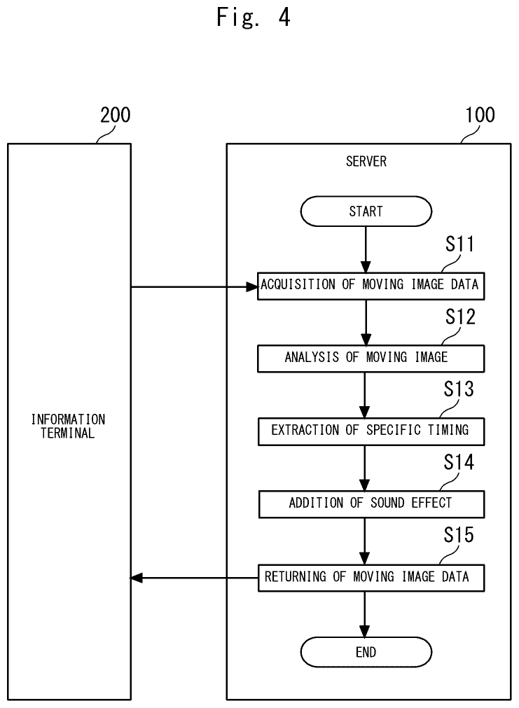

FIG. 4 is a flowchart illustrating an example operation of the editing system 1 of FIG. 1.

FIG. 4 illustrates an example of operation of the server 100 performed at the time of obtaining data of a moving image from the information terminal 200.

In operation S11, the server communication I/F 140 obtains data of a moving image from the information terminal 200. Then, in operation S12, the analysis unit 111 performs analysis such as calculation of a feature and detection of a person or an object in relation to the moving image that is obtained. Then, in operation S13, the timing extraction unit 112 extracts a specific timing in the moving image based on the analysis result of the moving image by the analysis unit 111. Then, in operation S14, the effect addition unit 113 adds an effect such as a sound effect to the specific timing extracted by the timing extraction unit 112. In the case where a plurality of specific timings are extracted by the timing extraction unit 112, the effect addition unit 113 adds an effect to each of the plurality of specific timings. Then, in operation S15, the server communication I/F 140 transmits data of the moving image to which an effect is added, to the information terminal 200.

A user checks the moving image returned from the server 100 on the information terminal 200, for example. After checking the moving image returned from the server 100, the user saves, delivers, or distributes the moving image, for example. Additionally, when the user, who is a poster, a distributor or the like of the moving image, transmits the moving image from the information terminal 200 to the server 100, the server 100 may, instead of returning the moving image subjected to the editing process to the user, distribute the moving image to another information terminal 200 that is used by another user to view the moving image. The server 100 may perform the editing process on a moving image that is being streamed, or may perform the editing process on a moving image that is delivered on demand.

Additionally, in the editing process on the moving image by the server 100 or the like, the processes in the operations such as analysis of the moving image, extraction of the specific timing, and addition of a sound effect may be, whenever possible, repeatedly performed, or performed in parallel, or performed in a different order, or omitted. For example, an example is described where the timing extraction unit 112 specifies a timing, and then, the effect addition unit 113 adds an effect to the specified timing, but the order of processes is not limited thereto. The processes may be performed in such an order that an appropriate timing is determined in relation to a specific effect, such as laughter, that is determined in advance, for example.

Furthermore, the analysis result of a moving image, the specific timing that is extracted, and the like may be information that is internally processed by the server 100 and not referred to from outside, or may be information that can be referred to from outside. By using a neural network or other machine learning methods, for example, the server 100 may take, as an input, a moving image that is obtained, and may output a moving image where a sound effect is added to a specific timing.

As described above, the method for editing a moving image according to the an example embodiment is performed by a computer such as the server 100, and includes extracting a specific timing in the moving image by analyzing the moving image that is obtained, and adding at least one sound effect to the specific timing. According to such a configuration, a sound effect is added to a specific timing that is extracted through analysis of a moving image including a temporal change, and thus, an audible effect according to the change in the moving image is appropriately added.

Furthermore, the method for editing the moving image is performed by a computer such as the server 100, and includes calculating a feature that is obtained by analyzing one or both of an image and a sound included in the moving image. Extraction of the specific timing is performed based on the feature that is calculated. Accordingly, a sound effect that visually or auditorily matches a change in the moving image is added, and editing of the moving image is more appropriately performed. By using both the image and the sound in analysis, a sound effect that better matches a context of the moving image may be added.

Furthermore, the method for editing the moving image is performed by a computer such as the server 100, and includes calculating a feature that is obtained by analyzing the moving image, and estimating a feeling of a person in the moving image based on the feature that is calculated. Extraction of the specific timing is performed based on the feeling of the person that is estimated. Accordingly, a sound effect that matches a change in the feeling of a person appearing in the moving image is added, and a sound effect that better matches a context of the moving image may be added.

Furthermore, the method for editing the moving image is performed by a computer such as the server 100, and includes detecting, in the moving image, a person or an object that is set in advance, by analyzing an image included in the moving image. Extraction of the specific timing is performed based on a result of detection of the person or the object. Accordingly, a sound effect that matches a person or an object appearing in the moving image is added, and a sound effect that better matches a context of the moving image may be added.

Moreover, addition of the sound effect is performed by referring to the sound effect table 151 that is set in advance to associate a type of a specific timing and a sound effect. Because the specific timing in a moving image and the sound effect are appropriately associated with each other in advance in the sound effect table 151, a sound effect that better matches a context of the moving image may be added. Moreover, because an existing sound effect can be added, a processing load on the server 100 and the like related to addition of a sound effect is reduced.

Furthermore, addition of the sound effect is performed by dynamically generating the sound effect based on an analysis result of the moving image at the specific timing. Accordingly, even in a case where there is no appropriate existing sound effect, a sound effect to be added is dynamically generated, and a sound effect that better matches a context of the moving image may be added. Furthermore, a sound effect for each of various contexts of the moving image does not have to be held in the server 100 or the like, and a required or desired storage capacity in the server 100 or the like may be reduced.

Additionally, with the editing system 1, the editing process on the moving image may be performed as a stand-alone process by the information terminal 200 without using the network 300, the server 100, or the like. At this time, the terminal control unit 210 performs the editing process on a moving image that is obtained from the camera 270 or an external device of the information terminal 200, for example, based on the editing program for a moving image stored in the terminal storage unit 280 or the like. The information terminal 200 in this case is an example of an editing device.

Additionally, AI technology may be used instead of or in combination with at least one or all of the analysis unit 111, the timing extraction unit 112, the effect addition unit 113 of the server control unit 110, and/or the sound effect table 151 in the server storage unit 150. The AI technology here includes machine learning, deep learning, and other equivalent technologies. For example, an AI engine where a large amount of data is learned may be built, and a moving image may be analyzed using the engine and an appropriate timing may be extracted, and an optimum or desirable sound effect may be extracted and added based on the analyzed moving image and the timing.

### Second Example Embodiment

In a second example embodiment, differences from the example disclosed in the first example embodiment will be described in detail. With respect to aspects not described in the second example embodiment, any aspect of the example disclosed in the first example embodiment may be adopted.

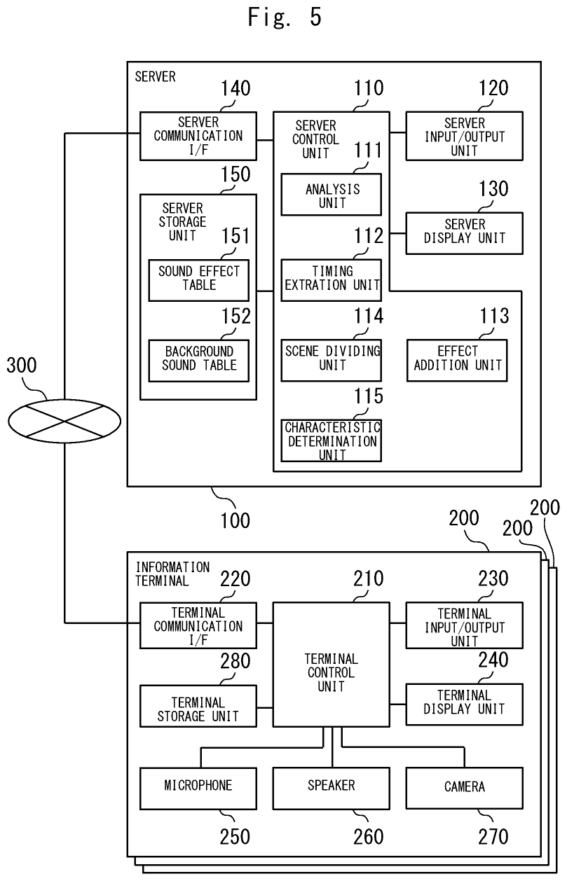

FIG. 5 is a diagram illustrating a configuration of each device included in the editing system 1 according to an example embodiment.

In the present example, the server control unit 110 adds a background sound as an audible effect, to each scene obtained by dividing an obtained moving image into a plurality of pieces. A background sound may be music such as background music (BGM), an environmental sound, or the like. A scene that is obtained by dividing a moving image is a section from a certain time point to another time point in the moving image that is a possible target to which a background sound is to be added.

The server storage unit 150 stores a background sound table 152. The background sound table 152 is a data table including information associating in advance a type of a scene in a moving image and a background sound.

The server control unit 110 includes the analysis unit 111, the timing extraction unit 112, the effect addition unit 113, a scene dividing unit 114, and a characteristic determination unit 115.

For example, the analysis unit 111 calculates the feature at each time point in a moving image through analysis of one or both of an image and a sound included in the moving image. For example, the analysis unit 111 extracts an utterance section in the moving image based on the feature of an image or a sound. An utterance section is a section in a moving image where a person is making an utterance. At the time of extracting the utterance section based on the feature of an image or a sound, for example, the analysis unit 111 identifies an utterer in the utterance section. For example, the analysis unit 111 extracts utterance contents in the utterance section based on sound source separation and sound contents. For example, the analysis unit 111 analyzes language such as the utterance contents, included in the moving image, in the utterance section where the utterer is identified.

For example, the analysis unit 111 detects, by image analysis, overall movement of a person in the moving image, or movement of each part of the person, such as a face, an eye, an eyebrow, a nose, a mouth, a hand, or a leg. For example, the analysis unit 111 may take an amount of such detected movement as the feature. The analysis unit 111 may estimate a feeling of a person in the moving image based on movement of a part of a face image of the person. The analysis unit 111 may take intensity of the feeling estimated based on an image and an amount of change in the intensity as the feature. Types of feeling to be estimated include joy, surprise, anger, and the like.

For example, the analysis unit 111 extracts, by sound analysis, on a per-person basis, a sound uttered by a person in the moving image by using sound source separation. At this time, the analysis unit 111 may identify the utterer by sound analysis. The analysis unit 111 may detect an increase or a decrease in the number of utterers participating in a conversation, based on the sound of each person extracted. The analysis unit 111 may calculate, as a feature, the number of utterers participating in a conversation. The analysis unit 111 calculates a feature expressing the feeling of a person from the extracted sound of the corresponding person. Features of a sound include power, pitch, MFCC, and other dynamic features, for example. The analysis unit 111 may estimate the feeling of a person based on the feature of the sound of the corresponding person in the moving image, for example. The analysis unit 111 may take intensity of the feeling estimated based on sound and an amount of change in the intensity as the feature. For example, in the case where a sound uttered by a person in the moving image is a song, the analysis unit 111 may extract information such as a rhythm and a key of the song.

For example, the analysis unit 111 may calculate a feature such as intensity of the feeling of a person in the moving image by using both image analysis and sound analysis. For example, when a smiling face of a person detected in the moving image by image analysis matches a laughing voice of the person detected by sound analysis, the analysis unit 111 estimates that the person is laughing, and calculates a corresponding feature. For example, the analysis unit 111 may identify an utterer in the moving image by using both image analysis and sound analysis. The analysis unit 111 may calculate a feature such as intensity of the feeling of a person in the moving image by using, in combination with language analysis, one or both of image analysis and sound analysis. For example, the analysis unit 111 may detect an increase or a decrease in the number of utterers participating in a conversation, based on the number of persons in the moving image and an extracted sound of each person. For example, the analysis unit 111 may calculate intensity of the feeling of a person based on an image of food in the moving image, linguistic characteristics of utterance contents “delicious” from the person in the moving image, and a feature of a sound “delicious” from the person.

The scene dividing unit 114 is a part that includes a function of dividing a moving image as a target of editing into one or more scenes to which a background sound may be added. The scene dividing unit 114 divides one moving image recorded as one file into one or more scenes, for example. The scene dividing unit 114 performs division into one or more scenes based on an analysis result from the analysis unit 111. For example, the scene dividing unit 114 divides a moving image including a plurality of scenes into a plurality of scenes as a result of scene division. For example, the scene dividing unit 114 performs processing on a moving image including only one scene by assuming, as a result of scene division, that the moving image includes only one scene.

For example, the scene dividing unit 114 performs division into one or more scenes based on a feature calculated by the analysis unit 111. For example, a feature that is used for scene division is a feature expressing speed of movement of a person in a moving image or a feature expressing intensity of a feeling of a person in the moving image. For example, the scene dividing unit 114 may perform scene division by using, as a timing of scene switching, a time point when the feature exceeds or falls below a threshold that is set in advance, or may perform scene division by taking, as one scene, a duration when the feature is higher or lower than a threshold that is set in advance, or may perform scene division by using, as a timing of scene switching, a time point when the feature takes a local maximum value or a local minimum value, or may perform scene division by using, as a timing of scene switching, a middle time point between a time point when a certain feature takes a local maximum value and a time point when another feature takes a local maximum value, or may perform scene division by using a time point in the moving image as a timing of scene switching according to any other criterion based on the feature.

For example, the scene dividing unit 114 performs scene division based on a result of language analysis by the analysis unit 111. For example, the scene dividing unit 114 may detect a timing of scene switching by applying pattern matching on utterance contents extracted by the analysis unit 111. For example, when a conjunction such as “so” or “now” is detected from utterance contents, the scene dividing unit 114 performs scene division by using a start time point of the utterance section including the conjunction as the timing of scene switching. For example, the scene dividing unit 114 may detect a timing of scene switching by performing clustering on the utterance contents extracted by the analysis unit 111. For example, the scene dividing unit 114 estimates a topic in each utterance section based on clustering. At this time, the scene dividing unit 114 performs scene division by using a time point when one topic is switched to another topic as the timing of scene switching.

For example, the scene dividing unit 114 performs scene division based on a result of sound analysis by the analysis unit 111. For example, the scene dividing unit 114 performs scene division based on a detection result of an utterance section. For example, the scene dividing unit 114 may perform scene division based on a length of a no-sound section. For example, a no-sound section is a silent section that is longer than a time of, for example, five seconds) that is set in advance. The scene dividing unit 114 may perform scene division based on an increase or a decrease in the number of utterers. For example, the scene dividing unit 114 may perform scene division by taking, as one scene, a period of time when the number of utterers is the same, or may perform scene division by taking, as a timing of scene switching, a time point when the number of utterers is increased or decreased.

For example, the scene dividing unit 114 performs scene division based on a result of image analysis by the analysis unit 111. For example, the scene dividing unit 114 performs scene division based on a result of detection of a person or an object in the moving image. For example, the scene dividing unit 114 may perform scene division based on an increase or a decrease in the number of persons or objects that are detected. For example, the scene dividing unit 114 may perform scene division by taking, as one scene, a period of time when a person or an object that is detected is the same, or may perform scene division by using, as a timing of scene switching, a time point when the number of persons or objects that are detected is increased or decreased. For example, the scene dividing unit 114 may perform scene division based on the type of a person or an object that is detected. For example, the scene dividing unit 114 may perform scene division by taking, as one scene, a period of time when a specific person or a specific object is detected, or may perform scene division by taking, as a timing of scene switching, a time point when a specific person or a specific object is detected or ceases to be detected.

For example, the scene dividing unit 114 may perform scene division by using, in combination, at least one or all of results of language analysis, sound analysis, and/or image analysis by the analysis unit 111. For example, when a timing of scene switching is not detected, the scene dividing unit 114 may perform processing by assuming that the moving image includes only one scene according to a result of scene division.

The characteristic determination unit 115 is a part that includes a function of determining a characteristic of each of one or more scenes divided by the scene dividing unit 114. For example, the characteristic determination unit 115 determines a characteristic of a scene divided by the scene dividing unit 114, based on an analysis result such as the feature calculated by the analysis unit 111 in relation to the scene. For example, a feature that is used for determination of a characteristic of a scene may be a feature expressing speed of movement of a person in a moving image or a feature expressing intensity of a feeling of a person in the moving image. For example, the characteristic determination unit 115 may determine a characteristic of a scene based on a representative value of the feature of the scene, such as a maximum value, a minimum value, or an average value, or may determine the representative value of the feature to be the characteristic of the scene.

For example, the characteristic determination unit 115 determines a characteristic of a scene based on a result of language analysis by the analysis unit 111. For example, the characteristic determination unit 115 performs, by text classification, classification into a scene characteristic set in advance, such as explanation, conversation, dance, song, meal, operation of a personal computer, or relaxation. For example, the characteristic determination unit 115 may perform scene classification based on a keyword such as an important word that is extracted from utterance contents in the scene, or may perform scene classification based on a topic that is estimated by clustering or the like. For example, the characteristic determination unit 115 determines a result of performing classification of a scene to be the characteristic of the scene.

For example, the characteristic determination unit 115 determines a characteristic of a scene based on a result of sound analysis by the analysis unit 111. For example, the characteristic determination unit 115 determines a characteristic of a scene based on an acoustic feature such as power, pitch, or MFCC calculated in relation to the scene. For example, the characteristic determination unit 115 may determine a characteristic of a scene based on a representative value of the acoustic feature of the scene, such as a maximum value, a minimum value, or an average value, or may determine the representative value of the acoustic feature to be the characteristic of the scene. For example, the characteristic determination unit 115 may perform classification of a feeling, such as anger, surprise, or joy, of a person in the moving image in the scene based on the acoustic feature calculated for the scene, and determine the result to be characteristic of the scene. The characteristic determination unit 115 may calculate intensity of the feeling of a person in the moving image in the scene, and determine the feeling classified according to the intensity to be the characteristic of the scene. For example, in the case where a person in the moving image sings a song in a scene, the characteristic determination unit 115 may determine information such as a rhythm and a key extracted by the analysis unit 111 to be the characteristic of the scene.

For example, the characteristic determination unit 115 determines the characteristic of a scene based on a result of image analysis by the analysis unit 111. For example, the characteristic determination unit 115 determines the characteristic of a scene based on a person or an object that is detected in the scene. For example, the characteristic determination unit 115 may determine the person or the object that is detected in the scene to be the characteristic of the scene.

For example, the characteristic determination unit 115 may determine the characteristic of a target scene by using, in combination, at least one or all of results of language analysis, sound analysis, and/or image analysis on the scene by the analysis unit 111. The characteristic determination unit 115 may determine the characteristic of a scene by using an analysis result not used for scene division. For example, the characteristic determination unit 115 may determine a characteristic “delicious noodles” or “not-so-delicious noodles” in relation to a scene, based on an image of noodles in the scene and a linguistic characteristic of utterance contents, such as “delicious” or “not so delicious”, of a person in the scene.

The effect addition unit 113 adds an effect to each of one or more scenes divided by the scene dividing unit 114. For example, the effect addition unit 113 adds an audible effect such as a background sound to each scene. Additionally, the effect addition unit 113 may add a silent sound as the background sound, to at least one or all of one or more scenes. That is, the effect addition unit 113 does not have to add a background sound that is not a silent sound to all the scenes divided by the scene dividing unit 114. Furthermore, a length of the background sound to be added by the effect addition unit 113 to a scene in the moving image does not necessarily have to match a length of the scene. A background sound, such as a BGM, to be added to a scene may be added in such a way that the background sound starts before a start time point of the scene or after the start time point of the scene. The background sound, such as a BGM, to be added to a scene may be added in such a way that the background sound ends before an end time point of the scene or after the end time point of the scene. The background sound, such as a BGM, to be added to a scene may be added in such a way that the background sound fades in or fades out. For example, the background sound, such as a BGM, to be added to a scene may be added in such a way that the background sound overlaps another background sound added to a scene before or after the scene.

For example, the effect addition unit 113 adds a background sound to each scene by referring to the background sound table 152 stored in the server storage unit 150. Here, the background sound table 152 associates the type of a scene determined according to the characteristic determined for the scene with a background sound corresponding to the type. For example, the background sound table 152 associates a background sound such as a relaxed BGM with the type of a scene with a characteristic “relaxation”. For example, the background sound table 152 associates a background sound such as an upbeat BGM with the type of a scene with a characteristic “dance”. For example, by referring to the background sound table 152, the effect addition unit 113 adds, as the background sound, a relaxed BGM to a scene for which a characteristic “relaxation” is determined. For example, by referring to the background sound table 152, the effect addition unit 113 adds, as the background sound, an intense BGM to a scene for which a feeling of anger is determined as the characteristic. For example, by referring to the background sound table 152, the effect addition unit 113 adds, as the background sound, a BGM with a fast tempo to a scene for which a fast movement is determined as the characteristic. For example, by referring to the background sound table 152, the effect addition unit 113 adds, as the background sound, sound of waves to a scene for which “ocean” is determined as the characteristic.

For example, the effect addition unit 113 adds a background sound that is dynamically generated, based on a characteristic of a divided scene. For example, the effect addition unit 113 uses a learning model that is learned in advance by a method such as machine learning, and adds, to a scene, a sound effect that is dynamically generated using the characteristic of the scene as an input. For example, the effect addition unit 113 may take a feature calculated for a scene as an input to the learning model. For example, the effect addition unit 113 may dynamically generate the background sound by AI technology, or may dynamically generate the background sound by another method. The background sound that is generated at this time may be a background sound that is newly generated, or may be a background sound that is obtained by dynamically setting a parameter of an existing background sound, such as intensity, key or tempo. For example, the effect addition unit 113 takes a length of a scene as an input to the learning model, and adds, to the scene, a background sound that is generated according to the length. For example, the effect addition unit 113 may take time-series data expressing a change in the feeling in a scene as an auxiliary input to the learning model, and add, to the scene, a background sound that is generated according to the change in the feeling. For example, the effect addition unit 113 adds, to a scene where a feeling of surprise is gradually intensified, a background sound such as a BGM that is dynamically generated in such a way that the feeling of surprise is gradually changed from weak to strong. For example, the effect addition unit 113 adds, to a scene where a feeling of joy changes from strong to weak to strong, a background sound such as a BGM that is dynamically generated in such a way that the feeling of joy is changed from strong to weak to strong. For example, the effect addition unit 113 may add, to a scene with a characteristic “delicious noodles”, a background sound such as a BGM that is dynamically generated according to the type of food “noodles”, and may add, to a scene with a characteristic “not-so-delicious noodles”, a background sound such as an off-key BGM that is dynamically generated.

For example, the effect addition unit 113 adds, to a scene where a person sings a song, a background sound such as a BGM according to the song. For example, when a rhythm and a key are extracted from the song in the scene by sound analysis or the like, the effect addition unit 113 may add, to the scene, a background sound such as a BGM that is dynamically generated according to the rhythm and the key. For example, when a keyword, such as an important word, is extracted from a song or a conversation in a scene by language analysis or the like, the effect addition unit 113 may retrieve lyrics of music based on the keyword or a word similar to the keyword. At this time, for example, the effect addition unit 113 may add, to the scene, as a background sound, a music section, in the retrieved music, where the keyword is included in the lyrics. For example, when a keyword, such as an important word, is extracted from a song or a conversation in a scene by language analysis or the like, the effect addition unit 113 may retrieve a title of music based on the keyword or a word similar to the keyword. For example, when a person or an object is detected in a scene by image analysis or the like, the effect addition unit 113 may retrieve a title of music based on the person or the object. For example, at this time, the effect addition unit 113 may add a part or all of the retrieved music to the scene as a background sound. For example, when a piece of music can be identified from utterance contents in a scene, the effect addition unit 113 may add a part or all of the music to the scene as a background sound. At this time, the utterance contents in the scene may include the name of the music or the name of a related artist, or may include other keywords or the like.

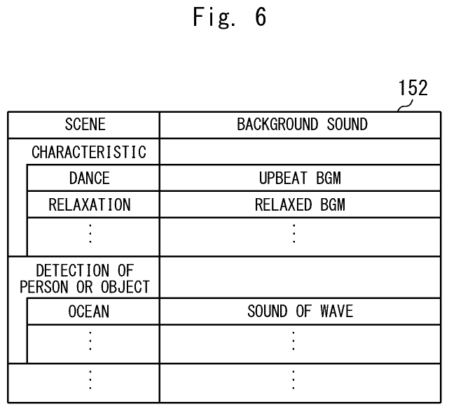

FIG. 6 is a table illustrating an example background sound table 152 of the editing system 1 of FIG. 5.

For example, the background sound table 152 associates a characteristic that is determined for a scene with a background sound corresponding to the characteristic. For example, the background sound table 152 associates an upbeat BGM to a characteristic “dance” of a scene. For example, the background sound table 152 associates a sound of waves to “ocean” detected in a scene.

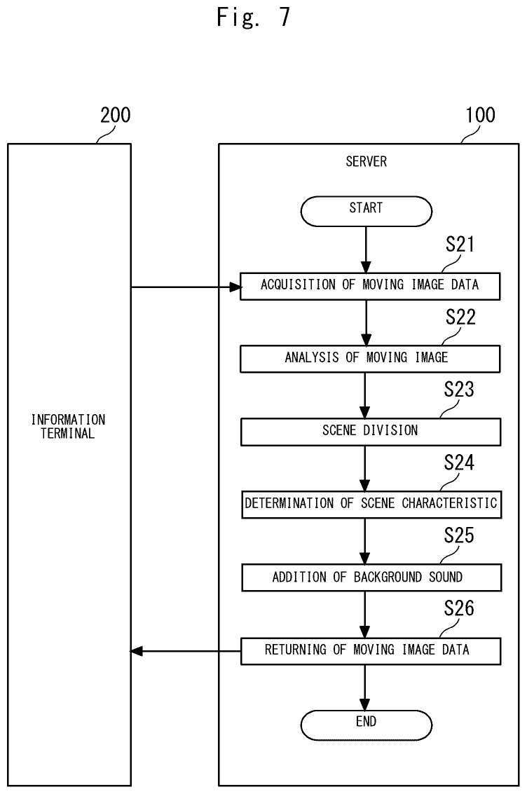

FIG. 7 is a flowchart illustrating an example operation of the editing system 1 of FIG. 5.

FIG. 7 illustrates an example of operation of the server 100 performed at the time of obtaining data of a moving image from the information terminal 200.

In operation S21, the server communication I/F 140 obtains data of a moving image from the information terminal 200. Then, in operation S22, the analysis unit 111 performs analysis such as calculation of a feature and detection of a person or an object in relation to the moving image that is obtained. Then, in operation S23, the scene dividing unit 114 divides the moving image into one or more scenes based on an analysis result of the moving image by the analysis unit 111. Then, in operation S24, the characteristic determination unit 115 determines a characteristic of each of the scenes divided by the scene dividing unit 114. Then, in operation S25, the effect addition unit 113 adds an effect such as a background sound to each of the scenes divided by the scene dividing unit 114, based on the characteristic determined by the characteristic determination unit 115. Then, in operation S26, the server communication I/F 140 transmits data of the moving image to which the effect is added, to the information terminal 200.

Additionally, in the editing process on the moving image by the server 100 or the like, the processes in the operations such as analysis of the moving image, scene division, determination of a characteristic of a scene, and addition of a background sound may be, whenever possible, repeatedly performed, or performed in parallel, or performed in a different order, or omitted. The analysis result of a moving image, a divided scene, a characteristic determined for a scene, and the like may be information that is internally processed by the server 100 and not referred to from outside, or may be information that can be referred to from outside. For example, by using a neural network or other machine learning methods, the server 100 may take, as an input, a moving image that is obtained, and may output a moving image where a background sound effect is added to each scene.

Furthermore, the server 100 may add one or both of a sound effect and a background sound to a moving image that is obtained.

Furthermore, the server 100 may add a sound effect and a background sound based on an attribute of a user. An attribute of a user may be age, generation, gender, region, a genre or a keyword of interest, a viewing history of moving images, a search history, or any other piece of information. An attribute of a user may include information about an attribute of another user who is registered as a friend of the user in question. For example, the server control unit 110 obtains information about an attribute of a user who edits a moving image, from the information terminal 200 that is operated by the user. For example, the server control unit 110 adds a sound effect and a background sound by using an attribute of the user as an auxiliary input. In some example embodiments, the server control unit 110 obtains, from the information terminal 200 or the like that is operated by the user who edits a moving image, information about an attribute of another user who is assumed by the user to be a viewer. Furthermore, in the case where the server 100 distributes a different moving image of the user who edits a moving image, information about an attribute of a different user who views the different moving image may be obtained from the information terminal 200 that is operated by the different user. For example, the server control unit 110 adds a sound effect and a background sound by using the attribute of the different user as an auxiliary input.

Furthermore, the server 100 may set a genre of an entire moving image based on the characteristic of a specific scene in the moving image. At time, the server control unit 110 adds a sound effect and a background sound to each scene in the moving image according to the genre set for the entire moving image. For example, the server control unit 110 may set the genre of the entire moving image based on the characteristic of an opening scene of the moving image, or may set the genre of the entire moving image based on the characteristic of a scene where a feature is the largest or the smallest.

Furthermore, the server 100 may present, to a user who edits a moving image, a reason for selecting the audible effect that is the sound effect added to the moving image. In the same manner, the server 100 may present, to a user who edits a moving image, a reason for selecting the audible effect that is the background sound added to the moving image. A reason for selecting an audible effect may include an analysis result from the analysis unit 111 used for selecting the audible effect, or may include other pieces of information.

Moreover, the server 100 may present, to a user who edits a moving image, a plurality of candidates for an audible effect, such as a sound effect, to be added to a specific timing in the moving image. In the same manner, the server 100 may present, to a user who edits a moving image, a plurality of candidates for an audible effect, such as a background sound, to be added to a scene in the moving image. The server 100 may also present a matching degree of the sound effect with the specific timing, or a matching degree of the background sound to the divided scene, in relation to the plurality of candidates. The server 100 may also present rankings of the matching degrees of the plurality of candidates. For example, the matching degree of a sound effect is calculated based on a feeling to which the sound effect added to a specific timing corresponds, and an intensity of the feeling estimated in relation to the timing. The matching degree of a background sound may be calculated in the same manner as the matching degree of a sound effect.

Moreover, the server control unit 110 may add, to a scene where a person sings a song, an audible effect according to which the singing voice is modulated by a voice changer or the like.

Moreover, the server 100 may collect evaluations regarding moving images other than the moving image that is obtained as a target of editing. For example, an evaluation of a moving image includes the number of times of playback of the moving image, and the number of high evaluations for the moving image. For example, evaluation of a moving image may be performed by the user who edited the moving image. For example, in the case where the server 100 distributes a moving image, the server 100 may collect an evaluation for the moving image that is distributed, from the information terminal 200 of a user who viewed the moving image. The server 100 may collect a moving image and an evaluation for the same from another service for distributing the moving image. For example, the server 100 adds a background sound to a moving image that is obtained as a target of editing, based on an evaluation collected for a different moving image and a background sound included in the different moving image. For example, the server 100 adds a background sound to a moving image that is obtained as a target of editing in such a way that a background sound that is similar to the background sound included in a highly evaluated moving image is added. In the same manner, the server 100 may add a sound effect to a moving image that is obtained as a target of editing, based on an evaluation collected for a different moving image and a sound effect included in the different moving image.

As described above, the method for editing a moving image according to the second embodiment is performed by a computer such as the server 100, and includes dividing the moving image into one or more scenes by analyzing the moving image that is obtained, determining a characteristic of each of the one or more scenes obtained by division, and determining a background sound to be added to each scene, based on the characteristic that is determined. According to such a configuration, a background sound is added to each of scenes that are divided by analyzing a moving image with a temporal change, and thus, an audible effect that is according to a change in the moving image may be appropriately added.

Furthermore, the method for editing the moving image is performed by a computer such as the server 100, and includes analyzing a language included in the moving image. Division into the one or more scenes is performed based on an analysis result of the language. Accordingly, a background sound that matches utterance contents in the moving image is added, and the moving image is more appropriately edited.

Furthermore, the method for editing the moving image is performed by a computer such as the server 100, and includes calculating a feature that is obtained by analyzing a sound included in the moving image. Division into the one or more scenes is performed based on the feature that is calculated. Accordingly, a background sound that auditorily matches a change in the moving image is added, and the moving image is more appropriately edited.

Furthermore, the method for editing the moving image is performed by a computer such as a server 100, and includes extracting an utterance section of an utterer in the moving image based on the feature that is calculated. Division into the one or more scenes based on the feature is performed based on the utterance section that is extracted. Accordingly, a background sound that matches a segment, in the moving image, including a conversation or the like is added, and the moving image is more appropriately edited.

Furthermore, in the method for editing the moving image, extracting the utterance section includes identifying the utterer in the moving image. Division into the one or more scenes based on the utterance section is performed based on a result of identification of the utterer. Accordingly, a background sound that matches the utterer appearing in the moving image is added, and the moving image is more appropriately edited.

Furthermore, the method for editing the moving image is performed by a computer such as a server 100, and includes calculating a feature that is obtained by analyzing an image included in the moving image. Division into the one or more scenes is performed based on the feature that is calculated. Accordingly, a sound effect that visually matches a change in the moving image is added, and the moving image is more appropriately edited.

Moreover, in the method for editing the moving image, addition of a background sound is performed by referring to the background sound table 152 that is set in advance to associate the type of each scene with a background sound. Because each scene in a moving image and the background sound are appropriately associated with each other in advance in the background sound table 152, a background sound that better matches a context of the moving image may be added. Moreover, because an existing background sound may be added, a processing load on the server 100 or the like related to addition of a background sound may be reduced.

Moreover, in the method for editing the moving image, addition of a background sound is performed by dynamically generating the background sound based on a result of analysis of each scene in the moving image. Accordingly, even in a case where there is no appropriate existing background sound, a background sound to be added is dynamically generated, and a background sound that better matches a context of the moving image may be added. Furthermore, a background sound for each of various contexts of the moving image does not have to be held in the server 100 or the like, and a required or desired storage capacity in the server 100 or the like may be reduced.

Furthermore, the method for editing the moving image is performed by a computer such as the server 100, and includes collecting an evaluation regarding another moving image different from the moving image that is obtained. Addition of a background sound is performed based on the evaluation for the other moving image that is collected, and the background sound included in the other moving image. Accordingly, a moving image is edited in such a way as to reflect a trend or the like so that a higher evaluation can be received.

Moreover, in the method for editing the moving image, addition of the background sound is performed based on an attribute of a user who edits or views the moving image. Accordingly, a background sound that matches a characteristic or the like of a user who edits or views the moving image may be added, and the moving image may be more appropriately edited.

Additionally, AI technology may be used instead of or in combination with at least one or all of the analysis unit 111, the timing extraction unit 112, the effect addition unit 113, the scene dividing unit 114, the characteristic determination unit 115 of the server control unit 110, the sound effect table 151 and/or the background sound table 152 in the server storage unit 150. The AI technology here includes machine learning, deep learning, and other equivalent technologies. For example, an AI engine where a large amount of data is learned may be built, a moving image may be analyzed using the engine, and division into an appropriate scene and addition of a characteristic may be performed, and extraction and addition of an optimum background sound may be performed based on the analyzed moving image, scene division and scene characteristic.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Moreover, not all of the elements of the first example embodiment illustrated in FIG. 2 and the elements of the second example embodiment illustrated in FIG. 5 are essential structures, and even if some of the elements illustrated in FIGS. 2 and 5 are not included in the device where the elements are actually mounted, the device falls within the scope of the present inventive concepts as long as it satisfies the claims described below.

What is claimed is:

1. A method for editing a moving image by a computer, the method comprising:
obtaining the moving image;
extracting a specific timing in the moving image by analyzing the moving image; and
adding at least one sound effect to the specific timing.

2. The method according to claim 1, wherein
the analyzing the moving image obtains a feature by analyzing an image included in the moving image, and
the extracting the specific timing is performed based on the feature.

3. The method according to claim 1, wherein
the analyzing the moving image obtains a feature by analyzing a sound included in the moving image, and
the extracting the specific timing is performed based on the feature.

4. The method according to claim 1, wherein
the analyzing the moving image obtains a feature by analyzing both an image and a sound included in the moving image, and
the extracting the specific timing is performed based on the feature.

5. The method according to claim 1, further comprising:
estimating a feeling of a person in the moving image based on a feature, wherein
the analyzing the moving image obtains the feature by analyzing the moving image, and
the extracting the specific timing is performed based on the feeling of the person.

6. The method according to claim 1, further comprising:
detecting, in the moving image, a person or an object that is set in advance, by analyzing an image included in the moving image, wherein
the extracting the specific timing is performed based on a result of detection of the person or the object.

7. The method according to claim 1, wherein
the adding the sound effect is performed by referring to a table that is set in advance to associate a type of the specific timing and the sound effect.

8. The method according to claim 1, wherein
the adding the sound effect is performed by dynamically generating the sound effect based on an analysis result of the moving image at the specific timing.

9. A method for editing a moving image by a computer, the method comprising:
obtaining the moving image;
dividing the moving image into one or more scenes by analyzing the moving image;
determining a characteristic of each of the one or more scenes; and
determining a background sound to be added to each of the one or more scenes, based on the characteristic determined for a corresponding one of the one or more scenes.

10. The method according to claim 9, wherein
the analyzing the moving image includes analyzing a language included in the moving image, and
the dividing the moving image is performed based on an analysis result of the language.

11. The method according to claim 9, wherein
the analyzing the moving image obtains a feature by analyzing a sound included in the moving image, and
the dividing the moving image into the one or more scenes is performed based on the feature.

12. The method according to claim 11, further comprising:
extracting an utterance section of an utterer in the moving image based on the feature, wherein
the dividing the moving image into the one or more scenes based on the feature is performed based on the utterance section.

13. The method according to claim 12, wherein
the extracting the utterance section includes identifying the utterer in the moving image, and
the dividing the moving image into the one or more scenes based on the utterance section is performed based on a result of identification of the utterer.

14. The method according to claim 9, comprising:
the analyzing the moving image obtains a feature by analyzing an image included in the moving image, wherein
the dividing the moving image into the one or more scenes is performed based on the feature.

15. The method according to claim 9, wherein
the determining the background sound is performed by referring to a table that is set in advance to associate a type of each of the one or more scenes and the background sound.

16. The method according to claim 9, wherein
the determining the background sound includes dynamically generating the background sound based on an analysis result of the moving image for each of the one or more scenes.

17. The method according to claim 9, further comprising:
collecting an evaluation regarding another moving image different from the moving image, wherein
the determining the background sound is performed based on a result of the evaluation and other background sound included in the other moving image.

18. The method according to claim 9, wherein
the determining the background sound is performed based on an attribute of a user who edits or views the moving image.

19. A non-transitory computer-readable storage medium storing an editing program, which when executed by at least one processor, causes a computer to perform the method according to claim 1.

20. An editing device configured to perform the method according to claim 1.
